(19) United States
(12) Patent Application Publication
(10) Pub. No.: US 2025/0171241 A1
(43) Pub. Date: May 29, 2025

(54) METHOD FOR MONITORING A PRODUCTION PROCESS IN A PRODUCTION LINE AND PRODUCTION LINE, IN PARTICULAR A FILLING LINE

(71) Applicant: Krones AG, Neutraubling (DE)

(72) Inventors: Peter LINDNER, Langquaid (DE); Andreas STEINER, Wenzenbach (DE); Robert SZWARC, Neutraubling (DE); Benedikt BOETTCHER, Bruckmühl (DE)

(21) Appl. No.: 18/959,129

(22) Filed: Nov. 25, 2024

(30) Foreign Application Priority Data
Nov. 28, 2023 (DE) 10 2023 133 224.4

(51) Int. Cl. B65G 43/08; B67C 3/00

(52) U.S. Cl. CPC B65G 43/08; B67C 3/007; B65G 2203/044

(57) ABSTRACT

A method is described for monitoring a production sequence having at least two serially connected production processes for the manufacture and/or processing of containers in a production line which comprises a filling of liquid products, is upstream therefrom or downstream therefrom, as well as a corresponding production line. Accordingly, data records are individually assigned to the containers throughout the production process. The data records are enriched with process- and/or container-specific production data while passing through the production processes. This allows the production line to be comprehensively optimized by tracking individual process steps and process results.

### CROSS REFERENCE TO RELATED APPLICATION

The present application claims priority to German Patent Application No. 10 2023 133 224.4 filed on Nov. 28, 2023. The entire contents of the above-listed application are hereby incorporated by reference for all purposes.

### TECHNICAL FIELD

The disclosure relates to a method for monitoring a production sequence having serially connected production processes for the manufacture and/or processing of containers in a production line and a corresponding production line, in particular filling line.

### BACKGROUND

It is known to link production data, such as inspection data, with information on all the handling stations in filling plants for individual process units, e.g. in the case of plastic bottles, the evaluation of wall thickness data, to which blow mold cavities, clamp numbers as well as heating mandrel numbers are assigned. Clusters of errors that can be assigned to specific cavities, clamps or heating mandrels are accordingly displayed, which facilitates troubleshooting.

### SUMMARY

It is also known to track containers in container handling machines using shift registers. Information assigned to the container is clocked through the machine using a rough clock and/or fine clock.

From EP 2 132 129 B1 it is also known to query the occupancy of mass conveyors and/or buffer lines for containers in a filling plant by means of one or more cameras.

The disadvantage is that error analyses are thus only possible for individual machines, and production can often only be optimized inadequately and/or in many individual steps.

There is therefore a need for improvement in this regard.

The stated object is achieved with the subject matter described herein. It is understood that the production line can be designed to carry out described method steps, and that corresponding method steps can be carried out with described functions of the production line.

Accordingly, the claimed method serves to monitor a production sequence having at least two serially connected production processes for the manufacture and/or processing of containers, in particular bottles, in a production line which comprises a filling of liquid products, is upstream therefrom or downstream therefrom. For this purpose, data records are assigned to the containers individually throughout the production process, i.e. at least from the beginning to its end, and these are enriched with process- and/or container-specific production data while passing through the production processes.

The claimed production line accordingly comprises a filler for filling liquid products into containers, in particular bottles, or is arranged upstream or downstream from a filler. The production line comprises at least two process units for the manufacture and/or processing of the containers which are serially connected to one another by at least one transport means, and a monitoring system which is designed to individually assign data records to the containers about a production sequence carried out in the process units and to enrich them with process- and/or container-specific production data while passing through the production processes, in particular according to the method according to at least one of the described embodiments.

In this way, cross-machine relationships that influence the respective line efficiency can be better identified and systematically analyzed in order to create appropriate optimization approaches on this basis if necessary.

The data records can be individually assigned to the containers in the region of at least one transport section with forced guidance of the containers in shift registers and enriched in particular with the production data of each production process passed through in this way.

The data records can be individually assigned to the containers in the region of transport sections without forced guidance of the containers, in particular for unordered mass transport of the containers or without first-in-first-out, by means of imaging transport tracking of the containers, and can be enriched in particular with the production data of the production process passed through in this way.

Likewise, the data records can be individually assigned to the containers in the region of transport sections without forced guidance of the containers, in particular in the case of one-way air transport of the containers or with first-in-first-out, by means of runtime monitoring with a constant production output immediately upstream therefrom, and in particular can be enriched with the production data of the production process passed through in this way.

The transport sections can be components of the process units or connect them.

The data records can also be viewed as virtual data backpacks of the individual containers or as information containers accompanying them electronically.

Production processes for manufacturing the containers are for example heating preforms and blowing plastic bottles. Processing here means all other production processes in the production sequence, for example labeling, filling liquid products into containers, packaging the filled containers, each with any associated inspections, for example at the entrance and/or exit of individual production processes or the process units designed for this purpose.

The production sequence can also be understood as a production cycle, whereby its beginning and end can in principle be determined arbitrarily, so that such a cycle does not have to concern either raw materials or end products.

The data records are thus used to identify or mark the individual containers and remain assigned to them throughout the entire production sequence or cycle to be monitored. For this purpose, the respective data record can comprise at least one number of the respective process unit known as a result of a machine configuration of the production line and an associated time stamp. For example, it is then indicated which processing unit (a heating mandrel, a clamp, a blow mold, a filling valve, a closing unit or the like) has received the container at what time.

The container-specific data record can include the data that are available at individual shift register positions of the process units to be processed or utilized transport means.

The data record can include, for example: information on a preform batch from a specific tipping point to the next tipping point when entering the shift register; an individual preform inlet temperature; an infrared absorption value at the shift register position of an associated measuring point; an individual preform temperature after heating at the respective shift register position; characteristic values from a blow curve analysis via a shift register concerning the containers at the blow wheel outlet and each associated blow cavity.

Using the time stamp and, for example, the last shift register position of the described data enrichment, the complete history of individual containers over the production sequence or cycle can be reconstructed, or possibly only a part thereof to be examined. For example, process data such as heating and blowing parameters of containers that burst in the filler can be traced, as well as individually associated preform inlet temperatures. These data may also have been written at an earlier point in time.

The data records can be read via shift register information from process control systems of individual process units, such as the blow molding machine, and used to optimize process parameters, for example to match specific preform inlet temperatures.

The respective container identification can be easily maintained or assigned using a shift register, for example via the respective time stamp and/or time elapsed in the shift register.

Physical marking of the containers themselves is therefore unnecessary.

Container tracking and data assignment is possible during transport without a forced guidance that determines or maintains the respective transport position in the container flow, which is provided, for example, in star clamps or oven clamps, by means of counting functions, time measurements and/or imaging monitoring. In air transport, for example, a counting function can be used after each empty run. Accordingly, it is not possible to monitor diversion switches that operate in relation to transport positions.

In the case of forced handling of containers, for example in a machine block, each container or each associated shift register position can be assigned in a database which handling unit, which handling station or which transport clamp (of a transport star) has further processed or transported a specific container. Corresponding information such as online measurement results (e.g. wall thickness, fill level, etc.) but also error information such as quality rejection (e.g. bottle burst, label crookedness, etc.) can be assigned to the individual container or the associated shift register position.

In the case of forced guidance or block applications, a 1:1 assignment of individual containers and transport positions (with regard to the product flow) to one another is always possible using shift registers. All associated process units with a plurality of (rotating) handling stations require information in this regard about their current (rotational) position. This can be provided, for example, by the respective drive such as a stepper motor, or derived from the cycle time, e.g. using a proximity switch at each handling station. Possible participants in a monitoring system based on shift registers are, for example, all process units that have a plurality of handling stations such as blow molding machines, rotary rinsers, preform oven chains, preform irradiation stars, orientation stars and, if applicable, transfer stars and/or labeling machines.

Without forced guidance of the containers, shift register positions could in principle also be used, for example in air transport applications which operate according to the first-in-first-out principle. However, since a defined 1:1 assignment (see above) does not have to be given throughout, e.g. as a result of a quality rejection, time offsets of the container transport can be used instead or in addition to identify containers and to assign the described data records.

For example, time offsets between individual containers remain almost identical in production phases in which all involved process units produce at line capacity. This can, for example, be sufficiently accurate to correct errors in the filler, such as “bursting bottles”, due to insufficient container quality, by means of a correction loop for the respective blow molding machine. Similarly, error patterns on cappers, labelers, shrink packers, mass transport devices or the like could be assigned to specific causes and/or machine setting parameters.

In addition, an assignment via a physical container marking would also be possible. Markings could, for example, be applied specifically to the first container after a production gap or after quality rejections at the subsequent process unit, e.g. by laser marking, direct printing, UV pen, etc. If there are no further rejection functions in transport sections without forced guidance or shift register assignment, a 1:1 assignment can also be (re)established in this way.

Particularly advantageous for a transition between forced container transport such as in a star clamp, filling valve, turntable, blow mold, etc., and a non-forced container transport without first-in-first-out such as at transfer points, with a mass flow and in buffer storage, is local continuous imaging container tracking from or to the respective transition from/to the forced container transport.

Such imaging transport tracking of the containers is possible with at least one camera by electronically marking each container in the field of view using image processing in a manner known in principle so that each container can be clearly identified and tracked in the mass flow. For this purpose, containers and their electronic markings can be transferred between the fields of view of a plurality of cameras in a known manner.

For a trackable transfer of containers from non-forced container transport to forced container transport, an overlap region is advantageous in which the containers are already force-guided, but are still tracked by means of camera tracking in order to transfer the data records of the container from the camera tracking to a machine register on this basis. Such an overlap region optionally has a length (in the transport direction) that corresponds to the diameter of the containers to be processed up to ten times thereof, for example a length of 0.05 to 1 m. The identification of the containers and associated process data obtained in this way can then be transferred to an associated machine shift register, for example for transport sections of rotary machines that cannot be sufficiently seen.

In addition, there is the possibility of camera tracking to a first-in-first-out region and back, for example if a transition, e.g. a ladder, runs over the conveyor.

This is done, for example, on an infeed screw or on an infeed sawtooth star, but is in principle also possible on a conveyor belt, an infeed conveyor or the like. Position-accurate synchronization is possible, for example, via a trigger light barrier, but can also be written directly from the imaging tracking system into the respective machine shift register (infeed screw or infeed sawtooth star) and further processed there.

The process steps or container handling carried out during container transport in the production line are recorded by the respective process unit (container handling machine) as process- and/or container-specific production data and stored as a data record accompanying the respective container along the production line, which consequently grows with each production process, but always remains assigned to the individual container, e.g. on the basis of the respective shift register positions and/or the imaging container tracking.

The production data can be measured actual values, target values, evaluation results of individual handling operations, but also status data and/or identification data of filling organs, capping organs, reactor chambers, cavities or the like. The production data may also include inspection results such as identified container defects and/or control criteria, e.g. for the subsequent rejection of individual containers.

The described monitoring system is designed in particular to transfer containers and associated data records from a forced transport with associated data management in shift registers (machine tracking) to a non-forced transport without first-in-first-out (imaging container tracking in the mass flow) and vice versa.

This data transfer is also advantageous because exclusively imaging container tracking is difficult or even impossible to implement if containers pass through transport sections that are not easily visible, and/or their appearance changes as a result of production or handling. In these regions, the forced guidance, i.e. the fixed transport position in the product flow, and the data management in shift registers allow the containers to be clearly identified and the data records to be assigned in non-optical ways and also facilitate the learning of the imaging container tracking after external changes to the containers, i.e. when there is correspondingly changed image information.

### BRIEF DESCRIPTION OF THE FIGURE

FIG. 1 shows an example embodiment of the disclosure in which a schematic plan view of a production line is illustrated.

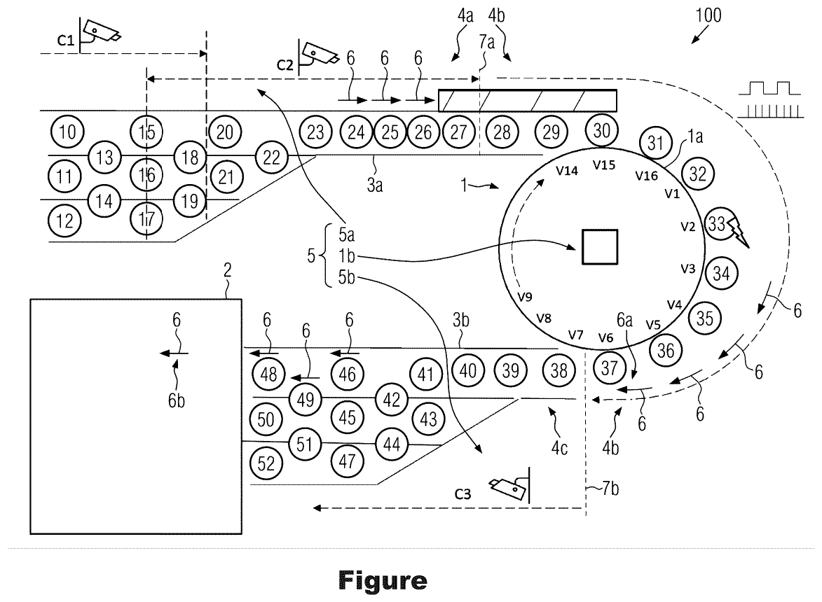

### DETAILED DESCRIPTION

Accordingly, the production line 100 comprises at least one first process unit 1 which here is, for example, a filler for filling liquid products into containers 10-52, and at least one second process unit 2 which here is, for example, a packer.

Immediately upstream of the first process unit 1 and between this and the second

process unit 2, transport means 3a, 3b are arranged for the non-forced transport of the containers 10-52 in the form of a random mass flow (without first-in-first-out).

The first process unit 1 further comprises a transport means 1a for the forced transport of the containers 10-52, here for example a container carousel with stations V1-V16 (filling valves) rotating around it and each receiving a container 10-52.

Accordingly, the transport means 3a, 3b form a first transport section 4a and a third transport section 4c for the non-forced transport of the containers 10-52, and the transport means 1a forms an intermediate second transport section 4b for the forced transport of the containers 10-52.

The production line 100 further comprises a monitoring system 5 which is configured to assign to the individual containers 10-52 individually accompanying data records 6 (only some of which are indicated schematically by arrows) relating to a production sequence carried out in the process units 1, 2, which here comprises an unordered transport of empty containers, the filling (and capping, not shown) of the containers, a random further transport of the filled containers to the packer, and the packaging of the containers 10-52.

The individual data records 6 of the containers 10-52 are enriched with process- and/or container-specific production data 6a or 6b while passing through the production processes, here during filling (and capping) and packaging.

For this purpose, the monitoring system 5 comprises a first tracking system 5a assigned to the first transport section 4a for imaging transport tracking of the containers 10-52 in the mass flow by means of cameras C1 and C2, a (machine) shift register 1b assigned to the second transport section 4b and thus to the first process unit 1, and a second tracking system 5b assigned to the third transport section 4c for imaging transport tracking of the containers 10-52 in the mass flow by means of a camera C3. The cameras C1-C3 can, for example, be arranged telecentrically above the associated transport means 3a, 3b.

By means of the tracking systems 5a, 5b and the shift register 1b, the data records 6 remain continuously assigned to the respective containers 10-52 during the production process and are enriched in the region of the process units 1, 2 with the production data 6a and 6b generated there. Accordingly, the data records 6 at the end of the production process each reflect an individual production history of the containers 10-52 and are optionally stored for later evaluation/product tracking, which is possible in a manner known in principle and is therefore not described further here. The data records may be stored in memory of a higher level control system having a processor and coupled with the components as described herein, and further coupled via a communication system for communicating data as described herein.

In the example, all containers 10-52 are identified by means of the first tracking system 5a and accordingly electronically marked, here with the numbers 10-52 and, for example, with current position information of the respective container 10-52 in at least one camera image as well as with additional information such as type and individual 2-D code which is assigned, for example, during manufacture (in a blow molding machine not shown).

When the containers 10-52 reach a first transfer point 7a between the first and second transport sections 4a, 4b, the associated data records 6 (if already available) are transferred from the first tracking system 5a to the shift register 1b. The data records 6 are guided there in the sense of a virtual information container or data backpack by means of a rotary encoder in a position-synchronous manner through the shift register 1b of the first process unit 1. The data records 6 are enriched with production data 6a which, for example, relate to the utilized station V1-V16 (filling valve), the utilized capping head, the filled product and/or the filling temperature. The production data 6a can also indicate fault conditions or the like. In the example, a damaged container 33 (e.g. broken bottle) is detected at station V2. This information is transferred to the data record 6 of the container 33 (the container with the previously assigned identification number 33). On this basis, the container 33 is diverted, for example, before reaching the second tracking system 5b. The associated, appropriately enriched data record 6 can then be transferred, for example, to a higher-level control system and stored, and is therefore no longer passed on to the second tracking system 5b at a second transfer point 7b.

The remaining containers 10-32 and 34-52 pass the second transfer point 7b, wherein their data records 6 enriched with production data 6a, e.g. with transfer coordinates for the second tracking system 5b are transferred thereto while retaining the container identification.

In the second process unit 2, the data records 6 of the containers 10-32 and 34-52 (remaining here) can be further enriched with the production data 6b generated there and thus completed and stored for the process sequence or process cycle shown here by way of example, e.g. for use in a higher-level control system (not shown).

1. A method for monitoring a production sequence having at least two serially connected production processes for the manufacture and/or processing of containers in a production line which comprises a filling of liquid products, is upstream therefrom or downstream therefrom, wherein data records are individually assigned to the containers throughout the production sequence and are enriched with process-specific and/or container-specific production data while passing through the production processes.

2. The method according to claim 1, wherein the data records are individually assigned to the containers in the region of at least one transport section with forced guidance of the containers in at least one shift register.

3. The method according to claim 2, wherein the containers pass forcefully guided through an enclosure, and/or are changed in terms of their appearance, and/or are treated in rotating stations, and/or are transported by rotating holders.

4. The method according to claim 1, wherein the containers are changed in the production processes with regard to their shape and/or with regard to their contents and/or with regard to their features.

5. The method according to claim 1, wherein the data records are individually assigned to the containers in the region of transport sections without forced guidance, which do not operate according to the first-in-first-out principle, by means of imaging transport tracking of the containers.

6. The method according to claim 1, wherein the data records are individually assigned to the containers in the region of transport sections without forced guidance, which operate according to the first-in-first-out principle, by means of runtime monitoring with a constant production output immediately upstream.

7. The method according to claim 1, wherein the data records accompany the containers electronically after each enrichment with the process and/or container-specific production data and are each stored after passage through the process units.

8. The method according to claim 1, wherein the process-specific production data represent at least one actual value of an associated treatment parameter determined in the respective production process, and the container-specific production data represent at least one container property determined immediately before, after or during the respective production process.

9. A production line which comprises a filler for filling liquid products into containers, is upstream therefrom or downstream therefrom, having at least two process units for the manufacture and/or processing of containers which are connected in series to one another by at least one transport means, and having a monitoring system which is configured to individually assign data records to the containers about a production sequence carried out in the process units and to enrich them with process and/or container-specific production data while passing through the production processes.

10. The production line according to claim 9, wherein the monitoring system comprises at least one shift register which is assigned to a process unit and/or a transport means in which the containers are force-guided, and wherein the monitoring system is configure to individually assign the data records to the containers by means of the shift register and, on this basis, to enrich them with the production data of the process unit and/or transport means passed through in this way.

11. The production line according to claim 9, wherein the monitoring system comprises at least one tracking system for imaging transport tracking of the containers, which is assigned to a process unit and/or a transport means in which the containers are not force-guided and wherein the monitoring system is configured to individually assign the data records to the containers by means of the tracking system.

12. The production line according to claim 9, wherein the monitoring system comprises an overlap region at a transition from non-forced to forced container transport in which the containers are already force-guided, but are still tracked by imaging in order to transfer the data records of the containers on this basis from a tracking system to a shift register for imaging transport tracking.

13. The production line according to claim 12, wherein the overlap region has a relative length that corresponds at least to the diameter of the containers to be processed up to ten times thereof, and/or has an absolute length of 0.05 to 1 m.

14. The production line according to claim 9, wherein the monitoring system comprises at least one runtime monitor system for measuring the runtime of individual containers, which is assigned to a process unit and/or a transport means in which the containers are not force-guided and wherein the monitoring system is configured to individually assign the data records to the containers by means of the runtime monitor system with a constant production output immediately upstream.

15. The production line according to claim 9, wherein the monitoring system is configured in such a way that the data records accompany the containers electronically after each enrichment with the process and/or container-specific production data and are further stored after passing through the process units with their production data.

16. The method according to claim 2, wherein the data records are enriched with the production data of the production process passed through.

17. The method according to claim 4, wherein the containers are changed in the production processes with regard to their shape by converting preforms into product containers for liquid filling materials, with regard to their contents by filling with a liquid filling material, and/or with regard to their features by labeling and/or capping.

18. The production line according to claim 11, wherein the monitoring system is configured to individually assign the data records to the containers by means of the tracking system and to enrich them on this basis with the production data of the process unit and/or transport means passed through in this way.

19. The production line according to claim 14, wherein the monitoring system is configured to individually assign the data records to the containers by means of the runtime monitor system with a constant production output immediately upstream, and to enrich them on this basis with the production data of the process unit and/or transport means passed through in this way.

20. The production line according to claim 15, wherein the data records and/or container-specific production data are transferred between at least the shift register, the tracking system and/or the runtime monitor system.

21. The method according to claim 7, wherein the containers are transferred between the transport sections with and without forced guidance.

22. The production line according to claim 11, wherein the transport means transports the containers in the form of random mass transport.

23. The production line according to claim 14, wherein the transport means transports the containers in the form of one-way air transport.
